(19) United States
(12) Patent Application Publication
(10) Pub. No.: US 2025/0369571 A1
(43) Pub. Date: Dec. 4, 2025

(54) CRYOGENIC FLUID STORAGE UNIT AND VEHICLE COMPRISING SUCH A UNIT

(71) Applicant: Faurecia Hydrogen Solutions France, NANTERRE (FR)

(72) Inventor: Frederic GREBER, ECOT (FR)

(21) Appl. No.: 19/220,245

(22) Filed: May 28, 2025

(30) Foreign Application Priority Data
May 31, 2024 (FR) 24 05702

(51) Int. Cl. F17C 9/00

(52) U.S. Cl. CPC F17C 9/00; F17C 2201/0109; F17C 2203/0345; F17C 2203/0629; F17C 2205/0323; F17C 2223/0161; F17C 2270/0168

(57) ABSTRACT

A storage unit comprises an internal reservoir and an external reservoir, where the internal reservoir and the external reservoir are separated from each other by an intermediate space. A cryogenic fluid transfer member is housed in the intermediate space, and the cryogenic fluid the transfer member comprises a body delimiting a chamber, an intake placing the chamber in communication with a cryogenic fluid storage volume delimited in the internal reservoir, a discharge, a movable member configured to move relative to the body by varying a volume of the chamber), a motor, and a mechanical transmission transmitting a movement from an output shaft of the motor to the movable member. The movable member is connected to the body by a bellows isolating the motor and the mechanical transmission from cryogenic fluid.

### CROSS-REFERENCE TO RELATED APPLICATION

This application is a U.S. non-provisional application claiming the benefit of French Application No. 24 05702, filed on May 31, 2024, which is incorporated herein by reference in its entirety.

### TECHNICAL FIELD

The present disclosure relates in general to the storage of a cryogenic fluid.

### BACKGROUND

A storage unit for receiving cryogenic hydrogen is generally designed to withstand internal pressures of between 1 and 27 bar. Above this pressure, the walls of the internal reservoir of the storage unit need to be very thick, and the mass of the storage unit becomes very significant. This is particularly disadvantageous for storage units intended to be installed on board vehicles.

For applications wherein hydrogen is to be used in an internal combustion engine, the hydrogen injection pressure is in the range of 40 to 200 bar. Indeed, it is necessary to inject hydrogen directly into the cylinders of the engine when the intake valves are closed, that is when the piston is rising. It is therefore essential to supply the hydrogen at a higher pressure than the current cylinder pressure. In addition, injecting at high pressure produces a more homogeneous mixture and improves combustion quality.

The internal combustion engine must therefore be supplied using a transfer member to increase the pressure of the cryogenic fluid.

It is possible to use piston pumps for this purpose.

The reliability of such pumps is very low. The bearings or rolling bearings of the engine have a short service life.

In this context, the disclosure aims to provide a cryogenic fluid storage unit equipped with a cryogenic fluid transfer member that offers improved reliability.

### SUMMARY

To this end, the disclosure relates to a cryogenic fluid storage unit, the cryogenic fluid storage unit comprising:
an internal reservoir, which internally delimits a storage volume for cryogenic fluid;
an external reservoir, wherein the internal reservoir is housed, the internal reservoir and the external reservoir being separated from each other by a low-pressure intermediate space;
a cryogenic fluid transfer member housed in the low-pressure intermediate space, the transfer member comprising a body delimiting a chamber, an intake placing the chamber in communication with the storage volume for the cryogenic fluid, a discharge placing the chamber in communication with a cryogenic fluid outlet outside the cryogenic fluid storage unit, a movable member configured to move relative to the body by varying the volume of the chamber, a motor, and a mechanical transmission transmitting a movement from an output shaft of the motor to the movable member;
the movable member being connected to the body by a bellows isolating the motor and the mechanical transmission from the cryogenic fluid.

As the movable member is connected to the body by a bellows which isolates the motor and mechanical transmission from the cryogenic fluid, the motor and mechanical transmission are not exposed to this cryogenic fluid. They are in contact with a vacuum prevailing in the low-pressure intermediate space. Guide bearings or rolling bearings of the output shaft of the motor, which are typically made of ceramic, do not seize when operating under vacuum. These bearings or roller bearings tend to seize in the presence of hydrogen, especially when it is in a gaseous form.

The cryogenic fluid storage unit may further comprise one or more of the following features, considered alone or according to any technically possible combinations:
the body is fitted directly to a flange attached to the internal reservoir;
the flange is attached around an internal outlet port of the internal reservoir, arranged at a low point of the internal reservoir;
the body comprises a cylinder with a longitudinal central axis and a cylinder head closing one longitudinal end of the cylinder, the movable member being a piston moving in the chamber in the longitudinal direction without friction against the cylinder;
the cryogenic fluid transfer member comprises a ring rigidly attached to an internal surface of the cylinder, the movable member having a head arranged longitudinally between the ring and the cylinder head, the bellows being compressible in a longitudinal direction and connecting in a sealed manner the head of the movable member to the ring;
the movable member comprises a longitudinal rod integral with the head, the transfer member comprising a ring for guiding the longitudinal rod in longitudinal translation, housed radially inside the bellows and rigidly attached to the ring;
the mechanical transmission comprises an eccentric mounted on the output shaft of the motor and a connecting rod connecting the eccentric to the longitudinal rod;
the intake comprises at least one intake valve mounted on the cylinder head, and the discharge comprises at least one exhaust valve mounted on the cylinder head;
the discharge comprises at least one exhaust duct arranged in the body, the at least one exhaust valve being interposed along the at least one exhaust duct;
the intake comprises at least one intake passage arranged through the cylinder head and opening directly into the internal outlet port, the at least one intake valve being interposed along the at least one intake passage.

According to a second aspect, the disclosure relates to a vehicle comprising an internal combustion engine having combustion chambers and a cryogenic fluid storage unit having the above features, the cryogenic fluid transfer member conveying the cryogenic fluid into the combustion chambers of the internal combustion engine.

### BRIEF DESCRIPTION OF THE DRAWINGS

Other features and advantages of the disclosure will become apparent from the detailed description given hereunder, by way of non-limiting indication, referring to the appended figures, among which:

FIG. 1 is a sectional view of a cryogenic fluid storage unit in accordance with the disclosure, taken in a vertical plane containing the central axis of the internal reservoir;

FIG. 2 is a front view of the storage unit shown in FIG. 1, with the bottom of the external reservoir partially removed to reveal the cryogenic fluid transfer member;

FIG. 3 is a sectional view of a part of the storage unit shown in FIGS. 1 and 2, viewed at the angle of arrows III in FIG. 2.

FIG. 4 is a perspective view of the transfer member shown in FIGS. 1 to 3, with a part of the body and a part of the bellows removed to reveal the movable member and the mechanical transmission;

FIG. 5 is a sectional view of the transfer member shown in FIG. 4, taken in a plane containing the output shaft of the motor and the longitudinal direction of movement of the movable member;

FIG. 6 is a perspective view of the cylinder head of the transfer unit, with a partial cutaway to reveal an exhaust valve and an intake valve; and

FIG. 7 is a simplified schematic depiction of a vehicle equipped with an internal combustion engine supplied by the storage unit shown in FIGS. 1 to 6.

### DETAILED DESCRIPTION OF THE DRAWINGS

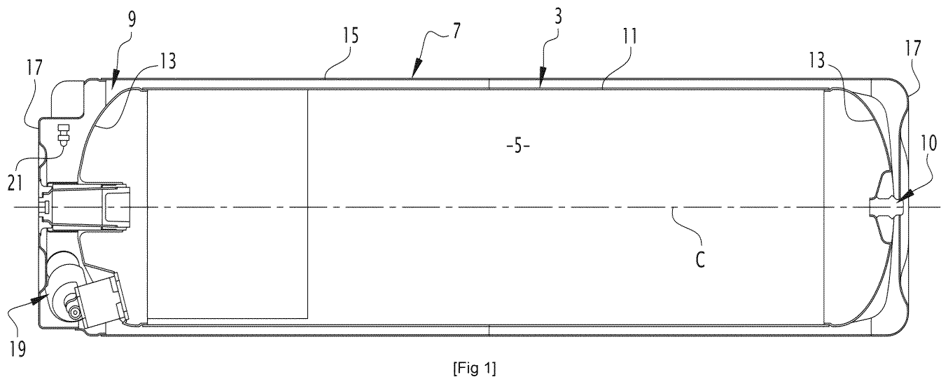

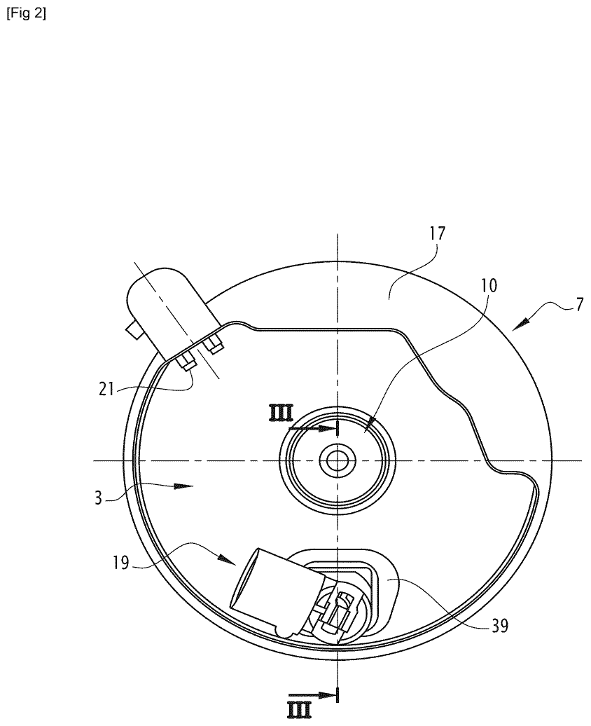

The cryogenic fluid storage unit 1 depicted in FIGS. 1 to 3 is intended to store a cryogenic fluid.

Cryogenic fluid is understood to mean a fluid at a very low temperature, which may be at least partially in the liquid state inside the storage unit 1.

This fluid is typically hydrogen. Alternatively, the fluid is a natural gas such as methane CH₄, ammonia or any other fluid suitable for an internal combustion engine. In another variant, the fluid is a cryogenic fluid such as helium, nitrogen, oxygen or any other fluid suitable for industrial installations.

The storage unit 1 is typically intended to be installed on board a vehicle, for example a motor vehicle, a train, a boat or any other vehicle.

The motor vehicle is, for example, a car, a utility vehicle, a truck, etc.

The storage unit 1 is typically designed to supply an internal combustion engine equipping a motor vehicle.

Alternatively, the storage unit 1 is designed to supply a fuel cell. For example, the fuel cell is configured to produce electricity and to electrically supply an electric propulsion motor of the vehicle.

The cryogenic fluid storage unit 1 comprises an internal reservoir 3 inwardly delimiting a cryogenic fluid storage volume 5, an external reservoir 7 housing the internal reservoir 3, the internal reservoir 3 and the external reservoir 7 being separated from one another by an intermediate space 9 maintained at low pressure.

A suspension 10 attaches the internal reservoir 3 to the external reservoir 7.

In the example shown, the internal reservoir 3 has a horizontal central axis C.

The internal reservoir 3 comprises a shell 11, closed at both opposite axial ends thereof by bottoms 13.

The shell 11 is cylindrical, centered on the central axis C.

The external reservoir 7 also has a horizontal axis.

It comprises a shell 15, closed at both opposite axial ends thereof by bottoms 17.

The shell 15 is cylindrical, centered on the central axis C.

Typically, the intermediate space 9 is maintained under a high vacuum.

This vacuum is typically of the order of 10-5 millibar, so as to strongly limit heat transfer by convection from the external reservoir 7 to the internal reservoir 3.

Thermal insulation (not shown) is interposed between the internal reservoir 3 and the external reservoir 7. The thermal insulation is typically placed on the external surface of the internal reservoir 3. The thermal insulation comprises for example a plurality of metal sheets superimposed on one another, with interposition of fiber layers.

The storage unit 1 further comprises a cryogenic fluid transfer member 19, housed in the intermediate space 9.

The transfer member 19 is configured to transfer cryogenic fluid from the storage volume 5 to other equipment, located outside the storage unit 1.

To this end, the storage unit 1 has a cryogenic fluid outlet 21. The cryogenic fluid outlet 21 is supported by the external reservoir 7. It is fluidically connected to the equipment supplied by the transfer member 19.

This equipment is for example a heat exchanger designed to heat the cryogenic fluid, or is a valve, or is the combustion propulsion engine of the vehicle, or else is a fuel cell.

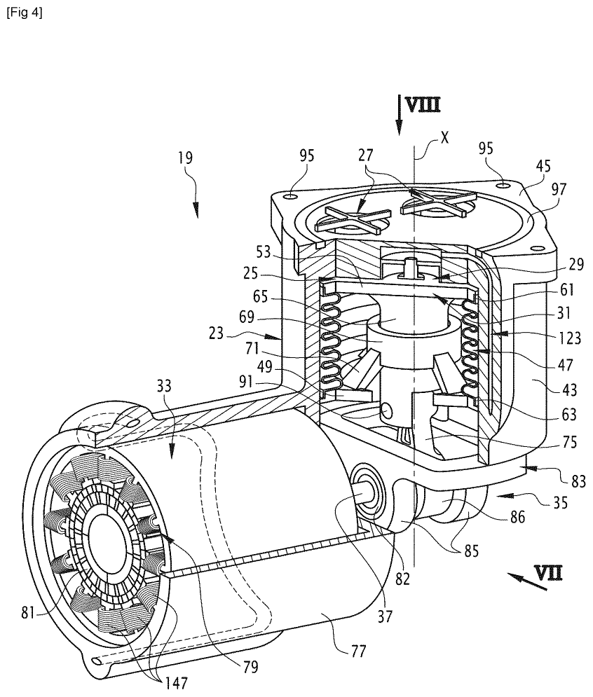

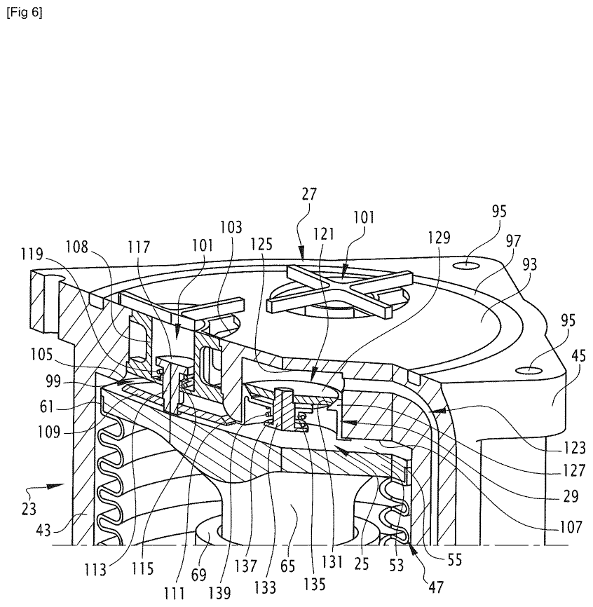

As can be seen more clearly in FIGS. 4 to 6, the cryogenic fluid transfer member 19 comprises a body 23 delimiting a chamber 25, an intake 27 placing the chamber 25 in communication with the cryogenic fluid storage volume 5, a discharge 29 placing the chamber 25 in communication with the cryogenic fluid outlet 21, a movable member 31 configured to move relative to the body 23 by varying the volume of the chamber 25, a motor 33, and a mechanical transmission 35 transmitting a movement from an output shaft 37 of the motor 33 to the movable member 31.

The transfer member 19 is housed entirely within the intermediate space 9, with no part of this transfer member 19 penetrating into the cryogenic fluid storage volume 5.

The body 23 is fitted directly to a flange 39 attached to the internal reservoir 3.

The flange 39 is attached around an internal outlet port 41 of the internal reservoir 3, arranged at a low point of the internal reservoir 3.

The internal outlet port 41 is arranged in one of the bottoms 13.

It is arranged at a low point of the internal reservoir in the sense that it is located, in the vertical direction, immediately above the lowest point of the cryogenic fluid storage volume 5.

In the example shown, the lowest point corresponds to the generatrix of the shell 11 facing downwards. The internal outlet port 41 is arranged immediately above said generatix. The top of the internal outlet port 41 is located, with respect to said generatrix, at a height of less than half the radius of the shell 11.

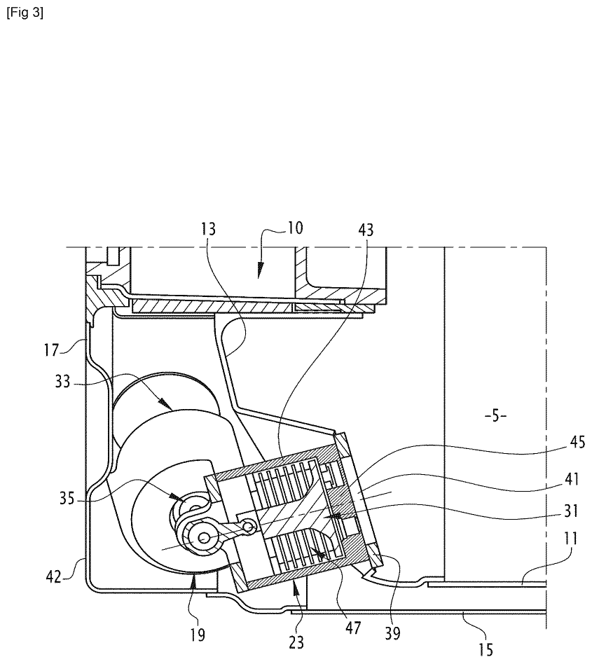

The external reservoir 7 comprises an access hatch 42 opposite the transfer member 19 (FIG. 3).

This access hatch 42 is arranged in one of the bottoms 17 of the external reservoir 7. It provides access to the transfer member 19, to perform any maintenance operations.

The body 23 comprises a cylinder 43 with a longitudinal central axis X, and a cylinder head 45 closing one longitudinal end of the cylinder 43.

The cylinder 43 is open at the longitudinal end thereof opposite the cylinder head 45.

The cylinder 43 has a circular internal cross-section perpendicular to the longitudinal axis X.

The movable member 31 is a piston which moves in the chamber 25 in the longitudinal direction X, without friction against the cylinder 43.

In other words, the transfer member 19 is of the piston pump type, thereby obtaining high discharge pressures.

The movable member 31 is connected to the body 23 by a bellows 47 isolating the motor 33 and the mechanical transmission 35 from the cryogenic fluid.

In other words, the bellows 47 creates a sealed barrier between the chamber 25 on one side, and the motor 33 and the mechanical transmission 35 on the other side.

The bellows 47 is connected in a sealed manner to the movable member 31. It is also connected in a sealed manner to the body 23, and more precisely to the internal surface of the cylinder 43.

The bellows 47 allows the movable member 31 to move and vary the volume of the chamber 25, without compromising the sealing of the chamber 25.

The transfer member 19 comprises a ring 49 rigidly attached to an internal surface 51 of the cylinder 43.

The movable member 31 comprises a head 53 arranged longitudinally between the ring 49 and the cylinder head 45.

The head 53 takes the form of a plate having, perpendicular to the longitudinal axis X, an external cross-section slightly smaller than the internal cross-section of the cylinder 43.

The head 53 has a flat surface 55 facing the cylinder head 45.

The bellows 47 is compressible in the longitudinal direction X.

The bellows 47 connects in a sealed manner the head 53 of the movable member 31 to the ring 49.

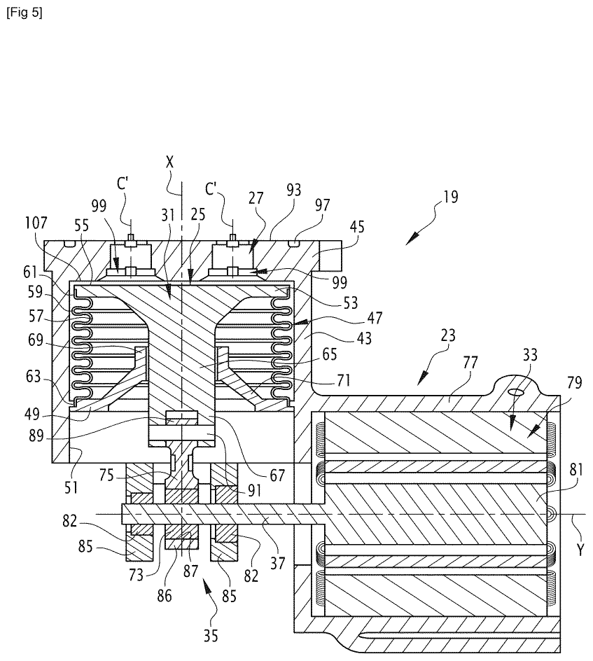

As can be seen from FIGS. 4 and 5, the bellows 47 is generally cylindrical in shape, and is coaxial with the longitudinal axis X. It is made of a metal sheet, of stainless steel, typically 316L type stainless steel, for example.

The bellows 47 has a general ribbed, that is corrugated, tube shape.

It comprises internal corrugations 57 projecting inwardly of the bellows 47, and external corrugations 59 projecting outwardly of the bellows 47. Each internal corrugation 57 is connected to two external corrugations 59, and reciprocally each external corrugation 59 is connected to two internal corrugations 57.

The internal corrugations 57 and the external corrugations 59 each extend along a closed contour around the longitudinal axis X.

Considered in section in a plane containing the longitudinal axis X, the wall of the bellows 47 has a sinuous shape.

A first longitudinal end 61 of the bellows 47 is rigidly attached to the head 53 of the movable member 31. The first longitudinal end 61 is attached in a sealed manner to the edge of the head 53, that is to the surface delimiting the head 53 in directions radially external with respect to the longitudinal axis X.

A second longitudinal end 63 of the bellows 47, opposite the first end 61, is rigidly attached to the ring 49 in a sealed manner. The ring 49 is itself attached in a sealed manner to the internal surface of the cylinder 43.

A seal is thus created between the second end 63 of the bellows 47 and the body 23.

Alternatively, the second end 63 of the bellows 47 is attached in a sealed manner directly to the internal surface of the cylinder 43.

The chamber 25 is thus delimited by the cylinder head 45, by the internal surface 51 of the cylinder 43, by the bellows 47 and by the head 53 of the movable member 31.

Its volume varies as the movable member 31 moves along the longitudinal axis X.

The travel of the movable member 31 defines the compressibility of the bellows 47.

To guarantee a very long service life for the bellows 47, the latter is designed for a billion compression/extension cycles.

According to one embodiment, this result is achieved by providing a 3 mm compression stroke for the bellows 47. This imposes a diameter of 100 mm, for example, given the desired flow rate for the transfer member 19 and the rotation speed of the motor 33.

The height of the bellows 47 is, for example, 60 mm longitudinally, and the thickness of the metal sheet constituting the bellows 47 is 1.5 mm, the bellows 47 in this case consisting, for example, of 5 plies of 0.3 mm each.

The movable member 31 further comprises a longitudinal rod 65 integral with the head 53.

The rod 65 projects from the head 53 along the longitudinal axis X, in a direction opposite to the cylinder head 45.

It extends along the central axis of the bellows 47 corresponding to the longitudinal axis X and terminates in an end 67 located axially outside the bellows 47, but inside the cylinder 43.

Alternatively, the end 67 is located inside the bellows 47.

The transfer member 19 further comprises a ring 69 for guiding the rod 65 in longitudinal translation.

The ring 69 is housed inside the bellows 47.

The ring 69 is cylindrical and has an internal cross-section slightly larger than the external cross-section of the rod 65.

The rod 65 is engaged in the ring 69 and is free to slide inside the ring 69.

The ring 69 is rigidly attached to the ring 49.

To this end, struts 71 distributed around the longitudinal axis X rigidly connect the ring 69 to the ring 49.

The mechanical transmission 35 comprises an eccentric 73 mounted on the output shaft 37 of the motor 33 and a connecting rod 75 connecting the eccentric 73 to the rod 65.

As shown in FIGS. 4 and 5, the body 23 comprises a cylindrical casing 77, integral with the cylinder 43. The motor 33 is housed in the cylindrical casing 77.

The motor 33 is an electric motor, with a stator 79 and a rotor 81. The output shaft 37 of the motor 33 is integral with the rotor 81. Alternatively, it is driven in rotation by rotor 81 via a reduction gearbox (not shown).

The output shaft 37 extends along a transverse axis Y, perpendicular to the longitudinal axis X.

The transverse axis Y intersects the longitudinal axis X.

The output shaft 37 is guided in rotation by two bearings 82.

The bearings 82 are preferably made of ceramic, thereby obtaining a long service life.

As shown in FIG. 4, the transfer member 19 comprises a support 83 rigidly attached to the body 23, defining two flanges 85 parallel to each other.

The bearings 82 are housed in orifices arranged in the flanges 85.

The support 83 is attached to the end of the cylinder 43 opposite the cylinder head 45.

The eccentric 73 and the connecting rod 75 are arranged between the flanges 85.

The eccentric 73 is rigidly attached to the output shaft 37.

The connecting rod 75 has a first end 86 comprising a circular slot 87 wherein the eccentric 73 is housed. The opposite end 89 of the connecting rod 75 is rotatably connected to the end 67 of the rod 65. It is coupled to the end 67 by a rotary axis 91, extending parallel to the transverse axis Y.

The body 23 is rigidly attached to the flange 39 via the cylinder head 45.

To this end, the cylinder head 45 has a flat external face 93 opposite from the chamber 25. The external face 93 is pressed against the flange 39.

The cylinder head 45 has orifices 95 intended to receive fasteners for the flange 39, not shown in FIGS. 4 and 5.

These orifices 95 are arranged in the lugs of the cylinder head 45.

The external face 93 also features a recessed groove 97, intended to receive a seal not shown. The seal is pinched against the flange 39 when the body 23 is attached to the flange 39.

The intake 27 comprises at least one intake valve 99 mounted on the cylinder head 45.

The intake 27 comprises at least one intake passage 101 arranged through the cylinder head 45 and opening directly into the internal outlet port 41.

The at least one intake passage 101 opens directly into the chamber 25.

The at least one intake valve 99 is interposed along the at least one intake passage 101.

In the example shown, the intake 27 comprises two intake passages 101, with an intake valve 99 interposed along each intake passage 101.

Alternatively, the intake 27 comprises a single intake passage 101 and a single intake valve 99, or three intake passages 101 and three intake valves 99, or even more than three intake passages 101 and more than three intake valves 99.

In any case, it is preferable to have the largest possible total passage cross-section for the cryogenic fluid through the intake passage(s) 101. It is thereby advantageous to have several intake passages 101.

The number of intake passages 101 and the cross-section of each intake passage 101 depend on the internal diameter of the cylinder 43.

Each intake passage 101 has an upstream orifice 103 opening onto the external face 93 of the cylinder head 45, and a downstream orifice 105 opening onto the internal face 107 of the cylinder head 45.

The internal face 107 is planar. It faces the chamber 25. It is opposite the external face 93. It delimits the chamber 25.

Each intake passage 101 therefore passes through the entire thickness of the cylinder head 45.

The or each passage 101 is straight. This means that the intake passage 101 has a straight central line C′. This central line C′ is perpendicular to the external face 93 and perpendicular to the internal face 107. It is parallel to the longitudinal axis X.

The or each intake valve 99 comprises a frame 108 rigidly attached to the cylinder head 45. The frame 108 is arranged in the corresponding intake passage 101.

The or each intake valve 99 further comprises a movable plate 109 which can be moved between a closed position of the intake passage 101 and a release position of the intake passage 101.

In the closed position, the movable plate 109 rests on a seat 111 formed in the cylinder head 45, at the downstream orifice 105 of the intake passage 101. In the release position, the movable plate 109 is lifted away from the seat 111, inwardly of the chamber 25.

The movable plate 109 carries a longitudinal axis 113, engaging with a guide sleeve 115 arranged in the frame 108. The longitudinal axis 113 and the guide sleeve 115 guide the movement of the movable plate 109 longitudinally between the release position thereof and the closed position thereof.

At its end opposite the movable plate 109, the longitudinal axis 113 carries a foot 117. An elastic member 119 is interposed between the foot 117 and the frame 108. The elastic member 119 is, for example, a helical compression spring.

The elastic member 119 returns the movable plate 109 to the closed position.

The discharge 29 comprise at least one exhaust valve 121.

The discharge 29 also comprises at least one exhaust duct 123 arranged in the body 23, with the at least one exhaust valve 121 interposed along the at least one exhaust duct 123.

In the example shown, the discharge 29 comprises two exhaust ducts 123, with an exhaust valve 121 interposed along each exhaust duct 123.

Alternatively, the discharge 29 comprises a single exhaust duct 123 and a single exhaust valve 121, or three exhaust ducts 123 and three exhaust valves 121, or more than three exhaust ducts 123 and more than three exhaust valves 121.

The or each exhaust duct 123 is arranged in the body 23 in the sense that the exhaust duct 123 is arranged in the material constituting the body 23.

Typically, the body 23 is made by casting, for example 316L type cast stainless steel or cast aluminum.

The or each exhaust duct 123 is the result of the casting process. In other words, the or each exhaust duct 123 is cast in one piece. It is arranged in the mass. It is not fitted to the body 23.

Alternatively, the or each exhaust duct 123 is machined into the body 23.

The exhaust duct(s) 123 are fluidically connected to the cryogenic fluid outlet 21.

The or each exhaust valve 121 is housed in a housing 125 formed in the cylinder head 45. This housing 125 forms the upstream end of the corresponding exhaust duct 123.

This housing 125 is open at the internal face 107 of the cylinder head 45 and closed at the external face 93.

The exhaust valve 121 is designed in the same way as the intake valve 99. It comprises a frame 127, integral with the cylinder head 45. This frame 127 is housed in the housing 125.

The exhaust valve 121 further comprises a movable plate 129 which can be moved between a release position of the exhaust duct 123 and a closed position of the exhaust duct 123. In the closed position, the movable plate 129 rests on a seat 131 formed in the frame 127. The seat 131 is formed in a ring-shaped portion of the frame 127, which itself is attached in a sealed manner to the internal surface of the housing 125.

In the release position, the movable plate 129 is lifted away from the seat 131, longitudinally towards the external face 93 of the cylinder head 45.

In other words, the movable plate 129 moves from the closed position to the release position along a longitudinal movement which moves it away from the internal face 107 of the cylinder head 45 and brings it towards the external face 93 of the cylinder head 45.

The movable plate 129 is integral with an axis 133 which projects longitudinally from the movable plate 129 towards the chamber 25.

The frame 127 comprises a ring 135 guiding the axis 133 in longitudinal translation.

At its opposite end to the movable plate 129, the axis 133 carries a foot 137. An elastic member 139 is interposed between the foot 137 and the frame 127. The elastic member 139 solicits the movable plate 129 towards its closed position.

The elastic member 139 is typically a helical compression spring.

The operation of the transfer member 19 will now be detailed.

The motor 33 rotates the output shaft 37.

The eccentric 73 rotates with the output shaft 37, inside the circular slot 87 arranged in the big end of the connecting rod 75. The connecting rod 75 converts the rotational movement of the output shaft 37 into a translational movement of the movable member 31. This moves longitudinally in a reciprocating motion, first away from the cylinder head 45 and then in the opposite direction towards the cylinder head 45.

Under the effect of this reciprocating motion, the bellows 47 is alternately compressed then longitudinally stretched.

When the movable member 31 descends, that is moves away from the cylinder head 45, the or each intake valve 99 opens under the effect of the pressure difference between the cryogenic fluid storage volume 5 and the chamber 25. This pressure difference is sufficient to overcome the return force of the elastic member 119. On the other hand, the or each exhaust valve 121 remains closed, the movable plate 129 being returned to its closed position by the elastic member 139 and by the pressure in the exhaust duct 123.

Cryogenic fluid can thus flow from the cryogenic fluid storage volume 5 into the chamber 25, through the or each intake passage 101.

As the movable member 31 rises, that is approaches the cylinder head 45, the pressure inside the chamber 25 increases. This leads to the closing of the or of each intake valve 99. The movable plate 109 is moved into its closed position under the effect of the pressure difference between the chamber 25 and the cryogenic fluid storage volume 5, and under the effect of the return force of the elastic member 119. Conversely, the or each exhaust valve 121 opens, as the movable plate 129 is moved into its release position under the effect of the pressure prevailing in the chamber 25. This pressure is sufficient to overcome the return force of the elastic member 139.

The cryogenic fluid is then expelled through the exhaust duct(s) 123.

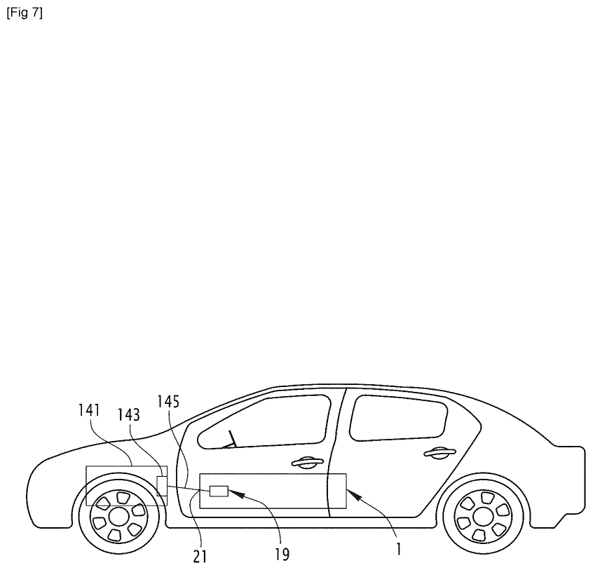

FIG. 7 shows a motor vehicle comprising an internal combustion engine 141 and a storage unit 1 as described hereinbefore.

The internal combustion engine 141 is of the type adapted to operate using cryogenic fluid as fuel.

It comprises combustion chambers 143. The transfer member 19 of the storage unit 1 conveys the cryogenic fluid into the combustion chambers 143 of the internal combustion engine 141.

To do this, the cryogenic fluid outlet 21 is fluidically connected to the combustion chambers 143 by a duct 145.

The transfer member 19 is configured to convey the cryogenic fluid at a pressure of between 25 and 200 bar, preferably 40 and 120 bar, and even more preferably 50 and 100 bar.

In the cryogenic fluid storage volume 5, the cryogenic fluid is stored at a pressure of between 1 and 20 bar.

The transfer member 19 is therefore a high-pressure transfer member, enabling the cryogenic fluid pressure to be raised significantly, from the storage pressure in the cryogenic fluid storage volume 5 to the injection pressure in the combustion chambers 143.

The storage unit 1 disclosed hereinbefore has multiple advantages.

When the body of the transfer member is fitted directly onto a flange attached to the internal reservoir, the storage unit is particularly compact.

When the flange is attached around an internal outlet port of the internal reservoir, arranged at a low point of the internal reservoir, priming of the transfer member is easy. Furthermore, it is possible to withdraw the cryogenic fluid even when the cryogenic fluid level in the storage volume is low.

When the body comprises a cylinder with a longitudinal central axis and a cylinder head closing the longitudinal end of the cylinder, the movable member being a piston moving in the chamber in the longitudinal direction without friction against the cylinder, it is possible to achieve high discharge pressures. This is achieved without piston wear. The bellows ensure no leakage.

When the transfer member comprises a ring rigidly attached to the internal surface of the cylinder, the movable member having a head arranged longitudinally between the ring and the cylinder head, the bellows being compressible in the longitudinal direction and connecting in a sealed manner the head of the movable member to the ring, the arrangement of the bellows inside the cylinder is particularly compact and convenient.

When the movable member comprises a longitudinal rod integral with the head, the transfer member comprising a ring for guiding the rod in longitudinal translation housed radially inside the bellows and rigidly attached to the ring, the movable member is guided in a particularly simple and convenient manner. The transfer member is extremely compact as the guide is housed inside the bellows and the cylinder.

A mechanical transmission comprising an eccentric mounted on the output shaft of the motor and a connecting rod connecting the eccentric to the rod is well suited to moving the movable member.

When the intake comprises at least one intake valve mounted on the cylinder head, and the discharge comprises at least one exhaust valve mounted on the cylinder head, the intake and exhaust valves are arranged in a particularly simple and convenient manner in the transfer member. This contributes to the compactness of the transfer member.

When the discharge comprises at least one exhaust duct arranged in the body, the at least one exhaust valve being interposed along the at least one exhaust duct, the overall dimensions of the transfer member are reduced.

When the intake comprises at least one intake passage arranged through the cylinder head and opening directly into the internal outlet port, the at least one intake valve being interposed along the at least one intake passage, the intake pressure losses of the transfer member are minimized.

The storage unit may have multiple variants.

The internal reservoir and the external reservoir can be arranged in different orientations. They are not necessarily horizontal axes but can for example be vertical axes.

The mechanical transmission is not necessarily of the eccentric connecting rod type. The mechanical transmission can be of the crank-rod type, a connecting rod transmission, or any other suitable type of transmission.

The motor is not necessarily arranged as shown in the figures, with an output shaft at right angles with respect to the direction of movement of the movable member. The motor can be of any type suitable for moving the movable member.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A cryogenic fluid storage unit comprising:
an internal reservoir internally delimiting a cryogenic fluid storage volume that stores cryogenic fluid;
an external reservoir, in which the internal reservoir is housed, the internal reservoir and the external reservoir being separated from each other by a low-pressure intermediate space;
a cryogenic fluid transfer member housed in the low-pressure intermediate space, the cryogenic fluid transfer member comprising a body delimiting a chamber, an intake placing the chamber in communication with the cryogenic fluid storage volume, a discharge placing the chamber in communication with a cryogenic fluid outlet outside the cryogenic fluid storage unit, a movable member configured to move relative to the body by varying a volume of the chamber, a motor, and a mechanical transmission transmitting a movement from an output shaft of the motor to the movable member; and
the movable member being connected to the body by a bellows isolating the motor and the mechanical transmission from the cryogenic fluid.

2. The cryogenic fluid storage unit according to claim 1, wherein the body is fitted directly to a flange attached to the internal reservoir.

3. The cryogenic fluid storage unit according to claim 2, wherein the flange is attached around an internal outlet port of the internal reservoir, arranged at a low point of the internal reservoir.

4. The cryogenic fluid storage unit according to claim 1, wherein the body comprises a cylinder with a central longitudinal axis and a cylinder head closing one longitudinal end of the cylinder, the movable member being a piston moving in the chamber in a longitudinal direction without friction against the cylinder.

5. The cryogenic fluid storage unit according to claim 4, wherein the cryogenic fluid transfer member comprises a ring rigidly attached to an internal surface of the cylinder, the movable member having a head arranged longitudinally between the ring and the cylinder head, the bellows being compressible in the longitudinal direction and connecting in a sealed manner the head of the movable member to the ring.

6. The cryogenic fluid storage unit according to claim 5, wherein the movable member comprises a longitudinal rod integral with the head, the cryogenic fluid transfer member comprising a ring for guiding the longitudinal rod in longitudinal translation, housed radially inside the bellows and rigidly attached to the ring.

7. The cryogenic fluid storage unit according to claim 6, wherein the mechanical transmission comprises an eccentric mounted on the output shaft of the motor and a connecting rod connecting the eccentric to the longitudinal rod.

8. The cryogenic fluid storage unit according to claim 4, wherein the intake comprises at least one intake valve mounted on the cylinder head, and the discharge comprises at least one exhaust valve mounted on the cylinder head.

9. The cryogenic fluid storage unit according to claim 8, wherein the discharge comprises at least one exhaust duct arranged in the body, the at least one exhaust valve being interposed along the at least one exhaust duct.

10. The cryogenic fluid storage unit according to claim 8, wherein a flange is attached around an internal outlet port of the internal reservoir, arranged at a low point of the internal reservoir, and wherein the intake comprises at least one intake passage arranged through the cylinder head and opening directly into the internal outlet port, the at least one intake valve being interposed along the at least one intake passage.

11. A vehicle comprising an internal combustion engine having combustion chambers and a cryogenic fluid storage unit according to claim 1, the cryogenic fluid transfer member conveying the cryogenic fluid into the combustion chambers of the internal combustion engine.
